(19) United States
(12) Patent Application Publication
(10) Pub. No.: US 2014/0316464 A1
(43) Pub. Date: Oct. 23, 2014

(54) DISSOLVABLE SUCK TRAINING DEVICE

(71) Applicant: Patricia Morgetano, Fonthill (CA)

(72) Inventor: Patricia Morgetano, Fonthill (CA)

(21) Appl. No.: 14/253,047

(22) Filed: Apr. 15, 2014

Related U.S. Application Data
(60) Provisional application No. 61/813,311, filed on Apr. 18, 2013.

(51) Int. Cl. A61J 13/00; A61J 17/00

(52) U.S. Cl. CPC A61J 13/00; A61J 17/00
USPC 606/236

(57) ABSTRACT

A device placeable over a nipple and shaped for easy latching. Sucking on the device draws the nipple inside the device to shape the nipple and draw it into the infant's mouth. The device then dissolves leaving the infant's mouth in direct contact with the nipple.

### FIELD OF INVENTION

This invention relates to breast feeding of babies. More particularly, this invention relates to training an infant to property latch onto a nipple.

### BACKGROUND OF THE INVENTION

Nipples, like babies' mouths, come in a variety of shapes and sizes. Some nipples are more difficult for a baby to latch onto for suckling than others.

Different mouth shapes differ in latching effectiveness. Small, large or inverted nipples pose a latching challenge as do ankyloglossia (being tongue tied) and small mouth circumference and other latching issues.

It is an object of the present invention to overcome at least some of the above latching issues.

### SUMMARY OF THE INVENTION

A device placeable over a nipple and shaped for easy latching. Sucking on the device draws the nipple inside the device to shape the nipple and draw it into the infant's mouth. The device then dissolves leaving the infant's mouth in direct contact with the nipple, thereby facilitating a direct mouth/nipple latch within that specific breastfeeding session.

A dissolvable suck training device is provided which has a cup with a concave face opposite a convex face and at least one fluid passage extending therebetween generally at or adjacent to an apex of the convex face to provide fluid communication therebetween. The convex face is contoured to provide a sucking surface for an infant's mouth to latch onto. The concave face is contoured to receive a nipple in response to suction being applied to the passage by the infant's mouth. The cup has a base extending thereabout opposite the apex for sealing about the nipple at least in response to the suction. The cup is of a non-toxic dissolvable material fit for infant consumption which dissolves in response to suckling in order to provide direct contact between the nipple and the infant's mouth.

At least the cup may be made of a pharmaceutical grade, preferably hypoallergenic gelatin, from at least one of: cattle hide; cattle bone; pork skin; poultry bone; fish bone; agar-agar; and, carrageen.

The base may have a flange extending outwardly about the cup.

The cup may have a conical shape.

### BRIEF DESCRIPTION OF THE DRAWINGS

The invention is described in detail below with reference to the accompanying illustrations in which:

FIG. 1 is a perspective view of a dissolvable suck training device (“device) according to the present invention.

FIG. 2 is a front elevational view of the device of FIG. 1; and

FIG. 3 is a section on line 3-3 of FIG. 1.

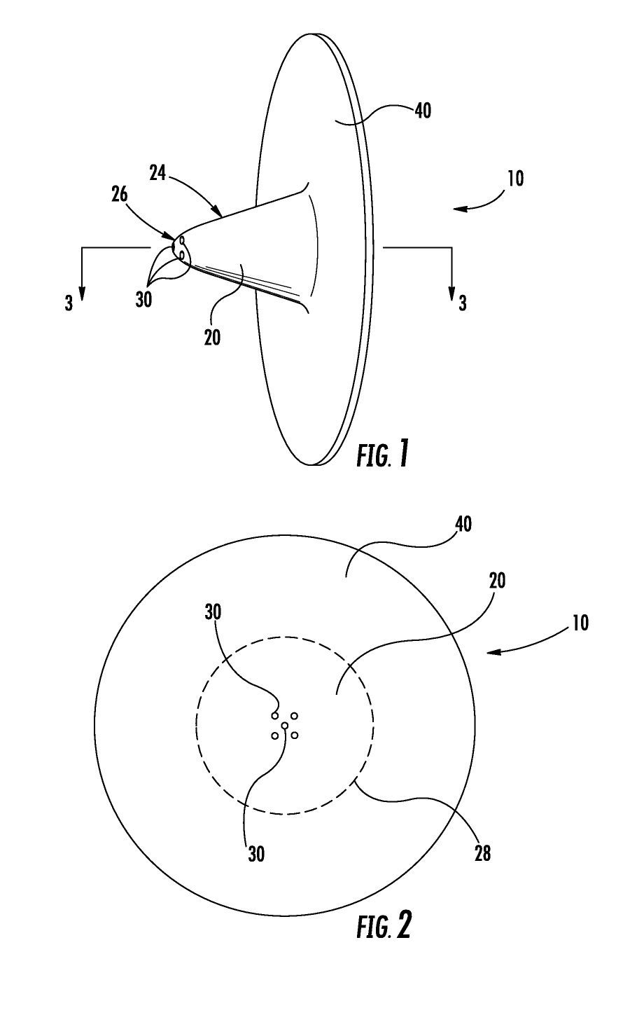

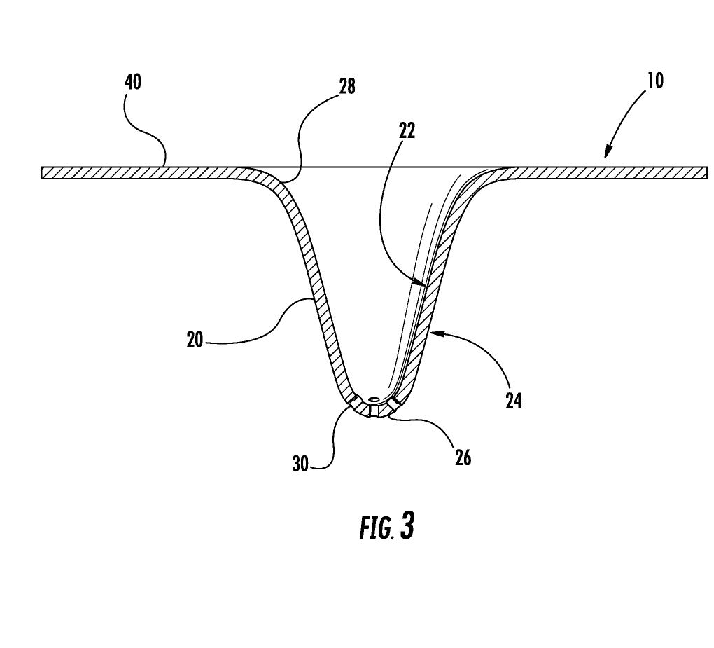

### DETAILED DESCRIPTION OF THE PREFERRED EMBODIMENTS

A dissolvable suck training device (“device”) according to the present invention is generally illustrated by reference numeral 10 in the accompanying illustrations. The device 10 has a cup 20 having a concave face 22 opposite a convex face 24. Passages 30 extend between the concave face 22 and the convex face 24 to allow fluid (milk) to flow from the concave face 22 through a wall of cup 20 to the convex face 22. The passages 30 would typically be located at or about an apex 26 of the cup 20 which is furthest from an open base end 28 of the cup 20. At least one passage 30 is required. A greater number may be provided.

The convex face 22 is contoured to provide a sucking surface for the baby to latch onto. Typically, the shape will be generally conical albeit with a rounded end at the apex 30 as illustrated.

The concave face 24 is contoured to receive a nipple in response to suction being applied to the passage by the infant's mouth during suckling.

In order to ensure adequate suction is applied to the nipple, the base 28 should seal about the nipple at least in response to the suction. This may be facilitated by providing an outwardly extending flange 40. Optionally, the flange 40 may be provided with a sticky surface for adhering to the nipple.

The device 10, or at least the cup portion 20 thereof, is of a dissolvable material which is non-toxic, safe for infant consumption and which dissolves as it is being sucked. The device 10 provides a shape onto which the infant can latch and, upon sucking, draws the nipple into the cup 20 of the device 10. At least the cup 20 dissolves leaving the infant to suck directly on the nipple.

Examples of suitable materials include pharmaceutical grade gelatins from at least one of cattle hide; cattle bones; pork skins; poultry bones; fish bones; agar-agar; and, carrageen. Preferably, the material will be hypoallergenic to reduce the risk of allergic reaction. Other suitable materials, which meet or exceed applicable government health guidelines, may occur to those skilled in the relevant art.

Expected benefits of the present invention include at least one of:
allows for baby to obtain a successful mouth to nipple latch within a breast feeding session;
supports and promotes baby's suck stimulation, mother's hormonal stimulation;
addresses psychological factors of mothers who struggle with breastfeeding by setting them up for success;
increased satisfaction and empowerment to the mother;
one time use, disposable with lower risk of germs and infections such as thrush; and,
more effective milk transfer from mom to baby.

The scope of the claims should not be limited by the preferred embodiments set forth in the examples, but should be given the broadest interpretation consistent with the description as a whole.

### LISTING OF REFERENCE NUMERALS USED IN THE DRAWINGS

10 device

20 cup

22 convex face

24 concave face

26 apex

28 base

30 passages

40 flange

What is claimed is:

1. A dissolvable suck training device comprising:
a cup having a concave face opposite a convex face with at least one fluid passage extending therebetween generally at or adjacent to an apex of said convex face to provide fluid communication therebetween;
said convex face being contoured to provide a sucking surface for an infant's mouth to latch onto;
said concave face being contoured to receive a nipple in response to suction being applied to said passage by said infant's mouth;
said cup having a base extending thereabout opposite said apex for sealing about said nipple at least in response to said suction; and
said cup being of a non-toxic dissolvable material fit for infant consumption which dissolves in response to said sucking to provide direct contact between said nipple and said infant's mouth.

2. The device of claim 1 where at least said cup is made of a pharmaceutical grade gelatin from at least one of: cattle hide; cattle bones; pork skins; poultry bones; fish bones; agar-agar; and, carrageen.

3. The device of claim 1, wherein said base has a flange extending outwardly about said cup.

4. The device of claim 2, wherein said base has a flange extending outwardly about said cup.

5. The device of claim 1, wherein said cup has a conical shape.

6. The device of claim 2, wherein said cup has a conical shape.

7. The device of claim 3, wherein said cup has a conical shape.

8. The device of claim 4, wherein said cup has a conical shape.
